(19) United States
(12) Patent Application Publication
(10) Pub. No.: US 2026/0367621 A1
(43) Pub. Date: Nov. 19, 2026

(54) METHOD AND SYSTEM FOR THE MUTUAL CHECKING OF THE INTEGRITY OF A PLURALITY OF AUTOMATION FIELD DEVICES

(71) Applicant: Endress+Hauser SE+Co. KG, Maulburg (DE)

(72) Inventors: Tobias Paul, Schopfheim (DE); Thomas Alber, Stuttgart (DE); Patrice Grosperrin, Rixheim (FR); Björn Haase, Stuttgart (DE); Michael Kuhl, Haldenwang (DE); Axel Pöschmann, Basel (CH); Johannes Sprenger, Lörrach (DE)

(21) Appl. No.: 19/139,440

(22) PCT Filed: Nov. 29, 2023
(86) PCT No.: PCT/EP2023/083460

§ 371 Date: Jun. 16, 2025

(30) Foreign Application Priority Data
Dec. 19, 2022 (DE) 10 2022 133 826.6

(51) Int. Cl. G05B 23/02

(52) U.S. Cl. CPC G05B 23/0254

(57) ABSTRACT

A method for the mutual checking of the integrity of a plurality of automation field devices comprises retrieving, by means of the communication unit of a first field device from the plurality of field devices, a current checksum of at least a second field device from the plurality of field devices; comparing the current checksum of the second field device with the corresponding checksum stored for the second field device in the memory unit of the first field device; and checking, by means of the electronics unit, whether the current checksum of the second field device deviates from the corresponding checksum of the second field device stored in the memory unit of the first field device. Also disclosed is a corresponding system.

The invention relates to a method for the mutual checking of the integrity of a plurality of automation field devices, wherein each of the field devices has at least one communication unit, wherein each of the communication units is designed to establish a communication connection to each of the other field devices via a communication network, wherein each of the field devices has a plurality of parameters which define the operation and/or the corresponding field device, and wherein each of the field devices additionally comprises an electronics unit and a memory unit. The invention further relates to a system comprising a plurality of field devices, wherein each of the field devices has at least one communication unit, which communication unit is designed to establish a communication connection to each of the other field devices via a communication network, wherein each of the field devices has a plurality of parameters which define the operation and/or functionalities of the field device.

Field devices that are used in industrial installations are already known from the prior art. Field devices are often used in process automation technology, as well as in manufacturing automation technology. In principle, all devices which are process-oriented and which supply or process process-relevant information are referred to as field devices. Field devices are thus used for detecting and/or influencing process variables. Measuring devices, or sensors, are used for detecting process variables. They are used, for example, for pressure and temperature measurement, conductivity measurement, flow measurement, pH measurement, fill level measurement etc., and detect the corresponding process variables of pressure, temperature, conductivity, pH value, fill level, flow, etc. Actuators are used for influencing process variables. These actuators are, for example, pumps or valves that can influence the flow of a fluid in a pipe or the fill level in a tank. In addition to the aforementioned measuring devices and actuators, field devices are also understood to include remote I/Os, radio adapters, or, generally, devices that are arranged at the field level.

A multitude of such field devices is produced and marketed by the endress+hauser group.

In modern industrial plants, field devices are usually connected to superordinate units via communications networks such as fieldbuses (Profibus®, Foundation® Fieldbus, HART®, etc.). Usually, the superordinate units are control systems (DCS) or control units, such as an SPC (stored program control). The superordinate units are used for, among other things, process control, process visualization, and process monitoring, as well as commissioning of the field devices. The measured values recorded by the field devices, especially by sensors, are transmitted via the respective bus system to a (or in some cases a plurality of) superordinate unit(s). In addition, data transmission from the superordinate unit via the bus system to the field devices is also required, especially for configuration and parameterization of field devices and for controlling actuators.

Existing field devices already have well over a hundred adjustable parameters, and the trend is rising. The manipulation of parameters, and thus the checking of the integrity of a field device, must be carried out manually, which causes considerable time and cost, in particular when a large number of field devices are used.

Proceeding from this problem, the object of the invention is to present a method that makes a simplified integrity check of field devices possible.

The object is achieved by a method for the mutual checking of the integrity of a plurality of automation field devices, wherein each of the field devices has at least one communication unit, wherein each of the communication units is designed to establish a communication connection to each of the other field devices via a communication network, wherein each of the field devices has a plurality of parameters which define the operation and/or the corresponding field device, and wherein each of the field devices additionally comprises an electronics unit and a memory unit, wherein the particular electronics unit is designed to generate a checksum across all parameters of the corresponding field device, and wherein the particular memory unit is designed to store the checksum of the corresponding field device and additionally the checksums of each of the other field devices, to which a communication connection can be established, comprising:
retrieving from the plurality of field devices, by means of the communication unit of a first field device, a current checksum of at least a second field device from the plurality of field devices;
comparing the current checksum of the second field device with the corresponding checksum stored for the second field device in the electronics unit of the first field device;
checking, by means of the electronics unit, whether the current checksums of the second field device deviate from the corresponding checksum of the second field device stored in the memory unit of the first field device.

According to the invention, field devices generate a secure checksum (e.g. a hash value) across all parameters of the field device. Such a checksum is unique for each device configuration (and therefore collision-free). If a parameter value changes, the checksum also changes, which eliminates the need to compare each individual parameter and its corresponding value. This checksum can be retrieved automatically by other field devices, wherein the existing plant infrastructure in the form of the communication network is used for communication between the field devices. Each device creates a list of which other field devices it can reach via the communication network and stores the corresponding checksums of these accessible field devices. The list of stored checksums is checked at particular periodic intervals.

This type of mutual monitoring represents a decentralized IDS (intrusion detection system), which allows the plant operator to react quickly to a potentially dangerous incident.

Examples of field devices that are mentioned in the method according to the invention have already been listed in the introductory part of the description.

In accordance with an advantageous embodiment, the method further comprises:
generating a warning in the event of a deviation of the current checksums of the second field device from the corresponding checksum of the second field device stored in the memory unit of the first field device.

A parameter change is necessarily accompanied by a checksum change. In other words, if a deviation occurs, this means that at least one parameter value has been changed. Such a change can, for example, be transmitted to a control system of the plant in which the field devices are installed. A cloud-based platform can also be considered as a destination for the transmission of the warning. The warning is transmitted in particular by the corresponding field device that detects the deviation.

In accordance with an advantageous embodiment of the method according to the invention, it is provided that a plausibility check of the deviation is carried out before the warning is generated and wherein the warning is only generated if the plausibility of the change cannot be successfully checked. For example, a check can be carried out as to whether the corresponding field device is in a service mode.

In accordance with an advantageous embodiment of the method according to the invention, it is provided that a plausibility of the change occurs when a user is authorized to change the parameters on the second field device. In this case, these are desired changes that do not trigger a warning.

In accordance with an advantageous embodiment of the method according to the invention, it is provided that the steps of retrieval and comparison are repeated at defined points in time, in particular at regular time intervals.

In accordance with an advantageous embodiment of the method according to the invention, it is provided that if a user gives the first field device a corresponding feedback when the warning is generated, the checksum of the second field device stored in the memory unit of the first field device will be overwritten with the current checksum of the second field device. The feedback then means that the change to the parameter values is desired. In this case, the old checksum is no longer valid and would constantly lead to warnings, e.g. new undesired changes would not be detected, which is why the stored checksum is overwritten.

In accordance with an advantageous embodiment of the method according to the invention, it is provided that in the event that a new field device is added to the communication network, its checksum is only stored after a first defined period of time has elapsed since the addition and/or since a last change of one or more of its parameters, in the respective memory units of the plurality of field devices. This prevents warning messages that would otherwise be generated by parameters changed in the course of commissioning a field device (and thus a changed checksum).

In accordance with an advantageous embodiment of the method according to the invention, it is provided that the checksums or the corresponding additional checksums are additionally formed via at least one item of software, in particular of firmware or an application, present on the corresponding field devices, or wherein first further checksums, or corresponding first further current checksums, are formed from the at least one software present on the corresponding field devices, which are compared correspondingly and checked for deviations. This means that not only unauthorized changes to the parameters of a field device but also, for example, a changed firmware version or changes to the device applications can be automatically detected.

The object is further achieved by a system comprising a plurality of field devices, wherein each of the field devices has at least one communication unit, which communication unit is designed to establish a communication connection to each of the other field devices via a communication network, wherein each of the field devices has a plurality of parameters which define the operation and/or functionalities of the field device, and wherein each of the field devices additionally comprises:
an electronics unit designed to generate a checksum across all parameters of the corresponding field device,
a memory unit which is designed to store the checksum, wherein additionally the checksums of each of the other field devices are stored in the memory unit, wherein each of the field devices is designed to retrieve the particular current checksums from each of the field devices to which a communication connection exists via the corresponding communication unit, wherein the electronics unit is designed to compare the current checksums with the checksums stored in the electronics unit and to generate a first warning in the event of a deviation of one of the current checksums from the corresponding stored checksum of at least one of the field devices.

In accordance with an advantageous embodiment of the system according to the invention, it is provided that each of the field devices is designed to detect a pattern of a network performance of each of the field devices to which a communication connection exists.

In accordance with an advantageous embodiment of the system according to the invention, it is provided that the network performance is determined on the basis of metadata, comprising, for example, packet size, packet count, sender addresses, and/or receiver addresses.

In accordance with an advantageous embodiment of the system according to the invention, it is provided that the corresponding electronics unit of the particular field devices is designed to generate a second warning in the event that the corresponding pattern of the network communication deviates by at least a defined amount from a predetermined pattern. In addition to retrieving the checksums of the other field devices, this establishes an additional security mechanism. This is also established as an IDS by the plurality of field devices and works on the same inventive idea that the field devices check each other's integrity mutually and independently. In accordance with an advantageous embodiment of the system according to the invention, it is provided that the field devices are designed to continuously record the pattern of a network performance of each of the field devices. Deviations from the known pattern can be detected immediately,

In accordance with an alternative advantageous embodiment of the system according to the invention, it is provided that the field devices are designed to detect the pattern of a network performance only at defined or random points in time, whereby resources can be saved.

In accordance with an advantageous embodiment, it is provided that the system further comprises a higher-level unit or a further network participant, in particular a PC, a gateway or a cloud, wherein the corresponding communication units of the respective field devices are designed to transmit the first warning and/or the second warning to the higher-level unit or to the other participant in the communication network. The transmission is carried out via the communication network and/or via the internet.

In accordance with an advantageous embodiment, it is provided that the target values of the checksums are configured centrally from the higher-level unit, which is in particular a PC, a gateway or a cloud, or that they are distributed within the mutually checking field device group. The transmission is carried out via the communication network and/or via the internet.

In particular, this includes the transmission of a signal by the higher-level unit to the field device group, which indicates that the checksums currently recorded in the plant are valid.

Advantageously, for the method according to the invention, the field device parameters are divided into a group of static parameters, for example device settings that are critical for operation, and a group of dynamic parameters, for example non-critical device settings or device settings that can be changed during normal operation, for example an operating hours counter or a setting parameter, a time display, or settings relating to summer time or winter time, and the checksum is calculated only via the static parameters. For the purposes of this disclosure, device parameters are understood to be static parameters.

The invention is explained in greater detail with reference to the following figure. In the figure:

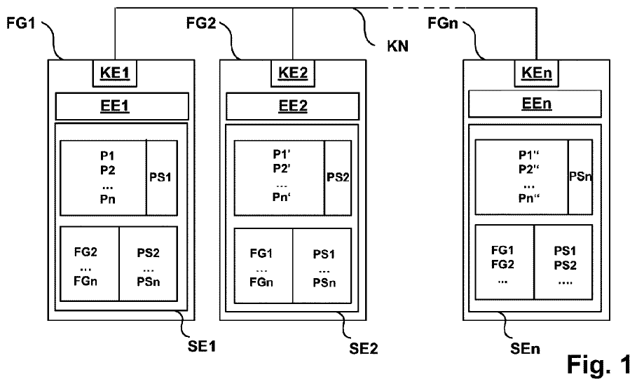

FIG. 1 shows a schematic of an embodiment of the method according to the invention.

FIG. 1 shows a plurality of field devices FG1, FG2, . . . , FGn, which are connected via corresponding communication units KE1, KE2, . . . , KEn to a communication network KN, in particular a fieldbus (e.g. Profibus or Foundation Fieldbus, or an Ethernet-based fieldbus). Each of the field devices FG1, FG2, . . . , FGn has a plurality of parameters Pn, Pn′, Pn″: The field device FG1 comprises the parameters P1, P2, . . . , Pn; the field device FG2 comprises the parameters P1′, P2′, . . . , Pn′; the field device FGn comprises the parameters P1″, P2″, . . . , Pn″.

The parameters Pn, Pn′, Pn″ define the operation of the particular field device FG1, FG2, . . . , FGn and also have security-relevant parameters, such as cryptographic keys, user authorization levels or access codes/passwords.

To protect against unwanted accidental changes or deliberate manipulation of the parameters Pn, Pn′, Pn″, each of the field devices FG1, FG2, . . . , FGn creates a current checksum PS1, PS2, . . . , PSn for all parameters Pn, Pn′, Pn″ by means of a corresponding electronics unit EE1, EE2, . . . , EEn.

Such a checksum PS1, PS2, . . . , PSn is unique for each device configuration (and therefore collision-free). If a parameter value of a parameter Pn, Pn′, Pn″ changes, the checksum of the corresponding field device FG1, FG2, . . . , FGn also changes.

An obvious method for determining the checksum is so-called cryptographic hash functions, such as those described in the RFC 6234 standard, e.g. SHA-256 or SHA-512.

To protect against accidental and/or intentional manipulation of the data during transmission on the network interface between the field devices FG1, FG2, . . . , FGn, the checksums for the transmission are advantageously transmitted together with a cryptographic checksum calculated using the checksum PS1, PS2, . . . PSn, in particular a cryptographic so-called message authentication code (MAC) or a cryptographic signature (SIG). In this case, the receiver first checks the cryptographic checksum (MAC/SIG) for correctness before checking the checksum PS1. If the network checksum (MAC or SIG) is calculated using a counter or timestamp (TS), so-called replay attacks on the network can also be advantageously detected. In order to make the verification of the cryptographic network checksums possible, a step is carried out during the commissioning of the field device group FG1, . . . , FGn in which the cryptographic keys (KEYa, KEYa′, KEYb, KEYb′ . . . , KEYm, KEYm′) required to generate and verify the network checksums (MAC/SIG) are distributed within the field device group. Examples of network checksums can be found in internet standards RFC 2104 and RFC 4493 (MAC) or RFC 8032 and RFC 8017 (SIG).

For example, the transmitting field device would calculate a network checksum NPS1 by means of a key KEYa stored there, based on the checksum PS1 and a timestamp TS1:
NPS1 =HMAC-SHA512((PS1, TS1), KEYa)

This network checksum is transmitted together with the PS1 and TS1 data. The receiver would use a key KEYa′ associated with KEYa to check the network checksum NPS1 and the timestamp TS1 for manipulations during transmission before checking the checksum PS1. In the case of message authentication codes, the same key KEYa=KEYa′ is used to verify the checksum NPS1 as was used to generate it. In the case of a signature procedure, the checksum NPS1 is calculated by means of a private key KEYa and the check of NPS1 is carried out using a key KEYa′ that is different from the private key KEYa.

By means of the corresponding communication units KE1, KE2, . . . , Ken, each of the field devices FG1, FG2, . . . , FGn retrieves the current checksums PS1, PS2, . . . , PSn of the other field devices via the communication network KN and stores them as a list in a particular memory unit SE1, SE2, . . . , SEn. This deposition process can be initiated, for example, via a signal from a higher-level PC unit or alternatively via operator guidance on a locally available display/operating module.

At several points in time, the field devices FG1, FG2, . . . , FGn retrieve the current checksums PS1, PS2, . . . , PSn of the other field devices and compare them with the stored checksums.

This process is described below for the field devices FG1, FG2:
The field device FG1 forms an updated checksum PS1 each time a parameter value P1, P2, . . . , Pn is changed;
The field device FG2 periodically requests the current checksum PS1 from field device FG1;
The field device FG2 compares the received current checksum PS1 with the stored list value.

In the event of a deviation, the FG2 field device generates a warning message, which is transmitted, for example, to the control center of the plant or to a cloud-based platform.

Before generating the warning, a plausibility check can be performed by the second field device FG2. For example, it is checked whether the field device FG1 was in a service or maintenance mode and parameter changes were allowed, whether an authorized user made the changes and/or whether the field device FG1 was recently put into operation so that parameter changes were likely. The warning is only created if the plausibility check is successful.

In addition, information regarding the software, such as firmware or applications, of the devices can be added to the checksum PS1, PS2, . . . , PSn. This can also be achieved by means of an additional checksum, which is also stored and regularly checked by the other field devices.

By means of the method or system according to the invention, a mutual and independent integrity check of the field devices FG1, FG2, . . . , FGn is possible.

The network communication of the field devices FG1, FG2, . . . , FGn can also be mutually monitored in order to detect unwanted manipulation or malfunctioning. Several metadata regarding the network performance are collected by the individual field devices FG1, FG2, . . . , FGn themselves. The metadata include, for example, packet size, packet count, sender addresses, and/or receiver addresses. From this data, the field devices FG1, FG2, . . . , FGn, or their electronics units EE1, EE2, . . . , EEn generate current patterns regarding the network performance. The principle corresponds to that of the checksums PS1, PS2, . . . , PSn of the parameters P1, P2, . . . , Pn: If metadata change, the pattern will change.

Analogously to the above description regarding the checksums PS1, PS2, . . . , PSn, the field devices FG1, FG2, . . . , FGn store the patterns of the other field devices and retrieve the current patterns of the other field devices at specified intervals and generate a warning in the event of a deviation.

### LIST OF REFERENCE SIGNS

EE1, EE2, . . . , EEn electronics units
FG1, FG2, . . . , FGn automation field devices
KE1, KE2, . . . , KEn communication units
KN communication network
Pn, Pn′, Pn″ parameters
PS1, PS2, . . . , PSn checksums
SE1, SE2, . . . , SEn memory units

1-17. (canceled)

18. A method for a mutual checking of an integrity of a plurality of automation field devices, wherein each of the plurality of field devices has a communication unit designed to establish a communication connection to each of the other field devices of the plurality of field devices via a communication network, wherein each of the plurality of field devices has a plurality of parameters that define an operation and/or the corresponding field device, and wherein each of the plurality of field devices additionally has an electronics unit and a memory unit, wherein each electronics unit is designed to generate a checksum across all parameters of the corresponding field device, and wherein the respective memory unit is designed to store the checksum of the corresponding field device and additionally store checksums of each of the other field devices of the plurality of field devices to which a communication connection can be established, the method comprising:
retrieving, via the communication unit of a first field device of the plurality of field devices, a current checksum of a second field device of the plurality of field devices;
comparing the current checksum of the second field device with a corresponding checksum stored for the second field device in the memory unit of the first field device;
checking, via the electronics unit of the first field device, whether the current checksum of the second field device deviates from the corresponding checksum of the second field device stored in the memory unit of the first field device.

19. The method according to claim 18, further comprising:
generating a warning in the event of a deviation of the current checksum of the second field device from the corresponding checksum of the second field device stored in the memory unit of the first field device.

20. The method according to claim 19, wherein a plausibility check of the deviation is carried out before the warning is generated and wherein the warning is generated only if the plausibility of the change cannot be successfully checked.

21. The method according to claim 20, wherein a plausibility of the change occurs when a user is authorized to change the parameters on the second field device.

22. The method according to claim 18, wherein the steps of retrieval and comparison are repeated at defined points in time.

23. The method according to claim 19, the method further comprising:
overwriting the checksum of the second field device stored in the memory unit of the first field device with the current checksum of the second field device. when a user gives the first field device a corresponding feedback when the warning is generated

24. The method according claim 18, wherein in the event that a new field device is added to the communication network, its checksum is only stored after a first defined period of time has elapsed since the addition, and/or since a last change of one or more of its parameters, in the particular memory units of the plurality of field devices.

25. The method according to claim 18, wherein the checksums are additionally formed via at least one item of software present on the corresponding field devices, or wherein further current checksums are formed from the at least one item of software present on the corresponding field devices, which are compared accordingly and checked for deviations.

26. The method according to claim 18, wherein cryptographic keys are stored in the memory of the field devices with which an integrity and authenticity check of the checksum information transmitted on the communication interface is carried out using cryptographic signatures or cryptographic message authentication codes that are generated by the second field device and transmitted together with the checksum information and checked by the first field device.

27. A system, comprising:
a plurality of field devices, each of the plurality of field devices including:
a communication unit designed to establish a communication connection to each of the other field devices of the plurality of field devices via a communication network;
a plurality of parameters which define the operation and/or functionalities of the particular field device;
an electronics unit designed to generate a checksum across all parameters of the corresponding field device; and
a memory unit designed to store the checksum and additionally checksums of each of the other field devices of the plurality of field devices,
wherein each of the plurality of field devices is designed to retrieve the respective current checksums from each of the field devices to which a communication connection exists via the corresponding communication unit,
wherein the electronics unit is designed to compare the current checksums with the checksums stored in the memory unit and to generate a first warning in the event of a deviation of one of the current checksums from the corresponding stored checksum of at least one of the field devices.

28. The system according to claim 27, wherein each of the plurality of field devices is designed to detect a pattern of network performance of each of the field devices to which a communication connection exists.

29. The system according to claim 28, wherein the network performance is determined on the basis of metadata including packet size, packet count, sender addresses, and/or receiver addresses.

30. The system according to claim 29, wherein the corresponding electronics unit of the respective field device is designed to generate a second warning in the event that the corresponding pattern of the network communication deviates from a predetermined pattern by at least a defined amount.

31. The system according to claim 28, wherein each of the plurality of field devices is designed to continuously detect the pattern of network performance of each of the field devices.

32. The system according to claim 28, wherein each of the plurality of field devices is designed to detect the pattern of a network performance only at defined or random points in time.

33. The system according to claim 30, further comprising:
a higher-level unit or a further network participant,
wherein the corresponding communication units of the respective field devices are designed to transmit the first warning and/or the second warning to the higher-level unit or the further network participant in the communication network.

34. The system according to claims 27,
wherein cryptographic keys are stored in the memory unit of each of the plurality of field devices, with which an integrity and authenticity check of the checksum information transmitted on the communication interface is carried out using cryptographic signatures or cryptographic message authentication codes that are generated by the second field device and transmitted together with the checksum information and checked by the first field device.
